(19) United States
(12) Patent Application Publication
(10) Pub. No.: US 2021/0357868 A1
(43) Pub. Date: Nov. 18, 2021

(54) SYSTEM AND PROCESS FOR COMMUNICATING JOB SKILLS INFORMATION TO JOB MARKET PARTICIPANTS

(71) Applicant: Lewis Talbot, Malibu, CA (US)

(72) Inventor: Lewis Talbot, Malibu, CA (US)

(21) Appl. No.: 16/874,952

(22) Filed: May 15, 2020

(51) Int. Cl. G06Q 10/10; G06Q 50/00

(52) U.S. Cl. CPC G06Q 10/1053; G06Q 50/01

(57) ABSTRACT

The present invention comprises a system and process for communicating job skills requirements to job market participants, including job seekers, employers, and educators. The system and process enable employers to post jobs on a platform and requires each job posting to include a list required job skills and the job skills that may be developed by an individual who is hired. Job seekers must maintain a current list of their job skills in the platform to apply to listed jobs, which, through drawing relationships among the job skills that are possessed by job seekers, that are required by employers, and that are acquirable through specific job opportunities, may inform both job seekers and educators as to which job skills are in most demand and need developed.

### CROSS REFERENCE

The present application claims the benefit of U.S. Provisional Patent Application No. 62/848,006 titled “System and Process for Communicating Job Skills Information to Job Market Participants,” filed May 15, 2019, the contents of which are incorporated in this disclosure by reference in its entirety.

### BACKGROUND

Embodiments of the invention described in this specification relate generally to job market opportunities, and more particularly, to a system and a process for communicating job skills information to job market participants.

The overall job market is currently facing a multitude of challenges. Underemployment is widespread among job seekers, including among those who have receive some form of accreditation from college-level institutions and above. At the same time, employers are unwilling to fill many job positions because the potential candidates, though often having earned university degrees, lack the job skills required to properly perform the role. Many individuals depart our educational systems feeling triumphant leaving with a diploma in hand, only to join the unemployed masses because they failed to acquire the necessary job skills along the way.

The underdeveloped skill sets that plague the unemployed are often due, in part, to a disconnect in the communication of the job skills required by employers to educational institutions. Educators are frequently unaware of the job skills being demanded of employers, and their inability to keep up with changing skills requirements contribute directly to a less qualified job candidate pool. Although educators attempt to attain information about skill set requirements, the methods to collect such information are time-consuming, inconsistent, unreliable, and/or are not actionable.

Methods commonly used by educators to collect employer skill set requirement information include human-conducted surveys and third-parties who collect information from job posting platforms. Human-conducted surveys have a number of drawbacks, that include the fact that they are prone to human error and can take months to organize and to execute—by the time employer skill set demands are established, many students have already graduated and the collected information cannot be used to improve their educational experiences. Similarly, information collected from job posting platforms are provided only periodically, and changes in employer skill set demands can go unnoticed for extended periods of time. Both methods lack objectivity and accuracy due to being based on relatively small sample sizes. They are utilized to collect general information, and they fail to help determine which skill sets are applicable to the jobs that are sought after by a specific educator's students. And finally, because no standardized system exists for collecting or interpreting job skill data, the conclusions drawn across educators pertaining to skills set requirements can vary greatly.

Accordingly, there is a need for standardized systems and processes for accurately determining employer job skills set requirements in real-time, and there is a need for means to communicate employer job skill set requirements to both job seekers and educators. Further, there is a need for systems and processes that enable educators to determine how current job skill set requirements align with the skills possessed by their students so that educators can take action to develop the skills lacked by their students at any given moment.

### BRIEF SUMMARY OF THE INVENTION

The present invention is a system and method for communicating job skills information among job market participants. Through the use of the Platform, Job Seekers, Employers, and Educators can each provide and retrieve certain information to and from the Platform to help facilitate the development of Job Skills among Job Seekers, the improvement of Job Seeker educations, and a more qualified pool of Job applicants.

The Platform provides a listing of Job opportunities and opportunities to acquire Job Skills as made available by Employers and/or Educators. Employers may list on the Platform Job Postings to which Job Seekers may save and/or apply to fill a Job position, and Educators may list on the Platform Educator Postings to which Job Seekers may save and/or apply to participate in an Educator Skills Program.

To list a Job Posting on the Platform, an Employer must access the Platform and provide the details of a particular Job, which may include any Required Skills that should be possessed by a Job Seeker who applies for the Job, and/or any Acquired Skills that are expected be attained throughout the Job experience by a Job Seeker who fills the Job position. Information pertaining to the Job Posting is saved to the Platform, and may be made available to view by Platform Users.

To list an Educator Posting on the Platform, an Educator must access the Platform and provide the details of a particular Educator Skills Program, which may include any Required Skills that should be possessed by a Job Seeker who applies for the Educator Skills Program, and/or any Acquired Skills that are expected be attained by Job Seekers who participate in the Educator Skills Program. Information pertaining to the Educator Posting is saved to the Platform, and may be made available to view by Platform Users.

To save and/or apply to either a Job Posting or Educator Posting, a Job Seeker must first create a User profile by providing information about the Job Seeker, which may include but is not limited to the Job Seeker's name, educational experience, student ID number, and/or the Job Skills possessed by the Job Seeker. The Job Seeker may then browse listings or search for Job Postings and/or Educator Postings on the Platform. The Platform may enable Job Seekers to conduct searches based on specific Job Skills or the Job Skill set attributable to the Job Seeker as added to the Job Seeker's User profile. Job Skill queries include but are not limited to requesting from the Platform the presentation of any Job Postings and/or Educator Postings that lists or omits a one or more Job Skills as Required Skills, requesting from the Platform the presentation of any Job Postings and/or Educator Postings that lists or omits one or more Job Skills as Acquired Skills, and/or requesting from the Platform the presentation of any Job Postings and/or Educator Postings for which the Job Seeker's User profile includes each and every Job Skill listed as a Required Skill.

Job Seekers may save and/or apply to listings via the Platform. One way a Job Seeker may save and/or apply to a listing is by allowing the Platform to share certain information associated with the Job Seeker's User profile. The Platform may be configured so that the Job Skills listed in the Job Seeker's User profile are compared to the Required Skills associated with the listing. If one or more Job Skills is named an Required Skill is not named in the Job Skills that comprise the Job Seeker's User profile, the Platform may either deny the Job Seeker the ability to save and/or apply to the listing or will allow the Job Seeker to save and/or apply to the listing but will communicate to the User who created that the Job Seeker does not possess one or more Required Skills.

In addition to providing a means for listing and applying Jobs and Educator Skills Programs, the Platform enables Job Seekers to evaluate their own Job Skills, track the Required Skills listed by Employers and Educators, and identify opportunities to acquire new Job Skills by tracking the Acquired Skills listed by Employers and Educators. The Platform facilitates these possibilities by enabling Job Seekers to group and store information about one or more Job Posting or Educator Posting to create one or more Posting Portfolios. For example, a Job Seeker may create a Posting Portfolio containing several Job Postings that have a certain job title. When a Posting Portfolio is created or updated, the Platform aggregates the Job Skill information for each Job Posting or Educator Posting in the Posting Portfolio, which may then be presented to the Job Seeker who created the Posting Portfolio so that the Job Seeker may derive such information as the most commonly occurring Job Skills and which Required Skills the Job Seeker currently lacks. The Job Seeker may then utilize this information to find and save and/or apply to listings that name as Acquired Skills the Job Skills the Job Seeker lacks in order to attain the Required Skills listed in the Posting Portfolio.

Educators may use the Platform to identify their Students' Job Skill deficiencies and to help their Students acquire the Job Skills they need. An Educator may input a list of students or other student-identifying information into the Platform, including but not limited to the name of the Educator's institution or a list of student ID numbers, and the Platform will identify any Job Seeker Users who have provided information to the Platform that matches the information provided by the Educator. Access to some of an Educator's Student's information may then be granted to the Educator. For example, an Educator may access a Student's Job Skills, Posting Portfolios, and information about the Job Skills, Required Skills, and/or Acquired Skills for each Posting Portfolio. An Educator may then evaluate a single Student and identify the Job Skills s/he is needing to acquire. An Educator may also use the Platform to access Job Skills information as it pertains to a group of Students, such as all of the Students with information stored by the Platform or all of the Students who list a particular major. Educators may use group Job Skills information to identify which Job Skills the Educators should focus on developing in specific groups of Students, and develop a plan to ensure their Students possess the Required Skills listed by Employers.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 conceptually illustrates a process for an Employer to create a Job Posting on the Platform.

FIG. 2 conceptually illustrates a process for an Educator to create an Educator Posting on the Platform.

FIG. 3 conceptually illustrates a process for a Job Seeker to input the Job Seeker's Job Skills into the Platform.

FIG. 4 conceptually illustrates a process for a Job Seeker to apply to a Job Posting or Educator Posting on the Platform.

FIG. 5 conceptually illustrates a process for a Job Seeker to save a Job Posting or Educator Posting to a Posting Portfolio in the Platform.

FIG. 6 conceptually illustrates a process for an Educator to identify Students and to access Student Job Skill information.

### DETAILED DESCRIPTION OF THE INVENTION

As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the terms and variations thereof have the meanings given below, unless a different meaning is clearly intended by the context in which such term is used.

An “Acquired Skill” is a skill that may be acquired by an individual through the participation in a Job or Educator Skills Program.

An “Educator” is an individual, group, entity, institution, organization, or establishment that provides instruction or educational services.

An “Educator Posting” is a presentation of certain information pertaining to an Educator Skills Program by means of a Platform.

An “Educator Skills Program” is an opportunity for a Job Seeker to acquire Job Skills as provided by an Educator.

An “Employer” is an individual, entity, institution, or organization, or establishment looking to obtain the services of at least one individual.

A “Job” is an opportunity to render services in exchange for or without compensation, including but not limited to an employment opportunity, a position requesting services from an independent contractor, an internship, an externship, an apprenticeship, a fellowship, or a volunteer position.

A “Job Posting” is a presentation of certain information pertaining to a Job by means of a Platform.

A “Job Seeker” is an individual looking to apply for a Job.

A “Job Skill” is an ability to do something well that is possessed by a Job Seeker and could be applied in at least one Job.

The “Platform” is a means for collecting, storing, sharing, and presenting information from, among, and to Job Seekers, Employers, and Educators via the internet.

A “Posting Portfolio” is a group of Job Postings specifically identified and saved to the Platform by a Job Seeker.

A “Required Skill” is a Job Skill that is listed in a Job Posting or Educator Posting as a prerequisite for a Job or admission to an Educator Skills Program, respectively.

A “Student” is a Job Seeker who is currently enrolled in a course or program provided by an Educator.

A “User” is a Job Seeker, Employer, or Educator that has been granted access to certain information stored by the Platform.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present disclosure is to be considered as an exemplification of the invention, and is not intended to limit the invention to the specific embodiments illustrated by the figures or description below.

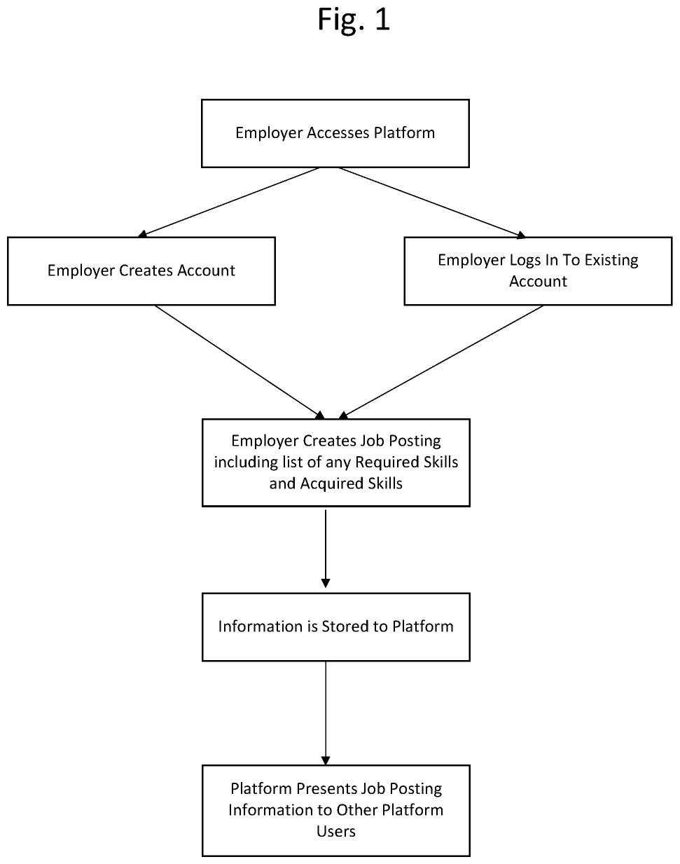

Referring now to the invention in more detail, FIG. 1 conceptually illustrates a process for an Employer to create a Job Posting on the Platform. The first step is for an Employer to access the Platform. This may be done using a computer, mobile device, or any other device that provides access to the internet. Subsequently, the Employer may either create an account on the Platform if they do not already have an account or log in to an existing account. Next, the Employer can create a Job Posting on the Platform by requiring information about the Job described in the Job Posting, including any Required Skills or Acquired Skills that pertain to the Job. To associate any Required Skills and/or Acquired Skills with the Job Posting, the Employer may select one or more Job Skills from a predefined list that is populated by a database of possible Job Skills, or the Employer may input their own custom Job Skill. Job Skills, including both Required Skills and Acquired Skills, may include any skill that could benefit the performance of a Job, including but not limited to specific computer or software skills, specific personal skills, or specific language skills. Next, information pertaining to the Employer's Job Posting is stored on the Platform. Finally, the Platform makes it possible for Users to view and interact with the Job Posting. Such interactions include but are not limited to applying to a Job listed in a Job Posting and saving a Job Posting for later access.

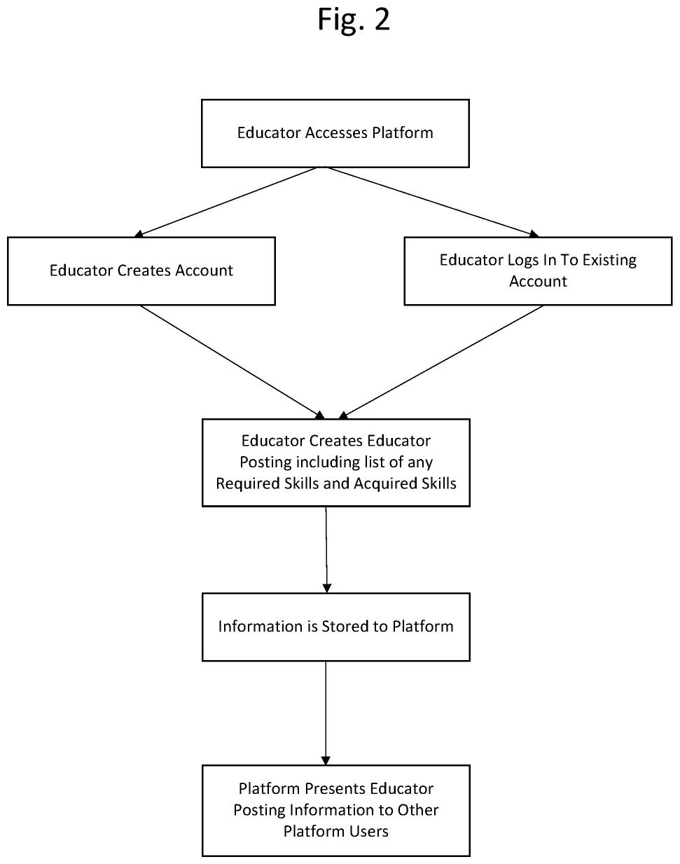

Referring now to FIG. 2, FIG. 2 conceptually illustrates a process for an Educator to create an Educator Posting on the Platform. The first step is for an Educator to access the Platform. This may be done using a computer, mobile device, or any other device that provides access to the internet. Subsequently, the Educator may either create an account on the Platform if they do not already have an account or log in to an existing account. Next, the Educator can create an Educator Posting on the Platform by requiring information about the Educator Skills Program described in the Educator Posting, including any Required Skills or Acquired Skills that pertain to the Educator Skills Program. To associate any Required Skills and/or Acquired Skills with the Educator Posting, the Educator may select one or more Job Skills from a predefined list that is populated by a database of possible Job Skills, or the Educator may input their own custom Job Skill. Job Skills, including both Required Skills and Acquired Skills, may include any skill that could benefit the performance of a Job, including but not limited to specific computer or software skills, specific personal skills, or specific language skills. Next, information pertaining to the Educator's Educator Posting is stored on the Platform. Finally, the Platform makes it possible for Users to view and interact with the Educator Posting. Such interactions include but are not limited to applying to an Educator Skills Program listed in an Educator Posting and saving an Educator Posting for later access.

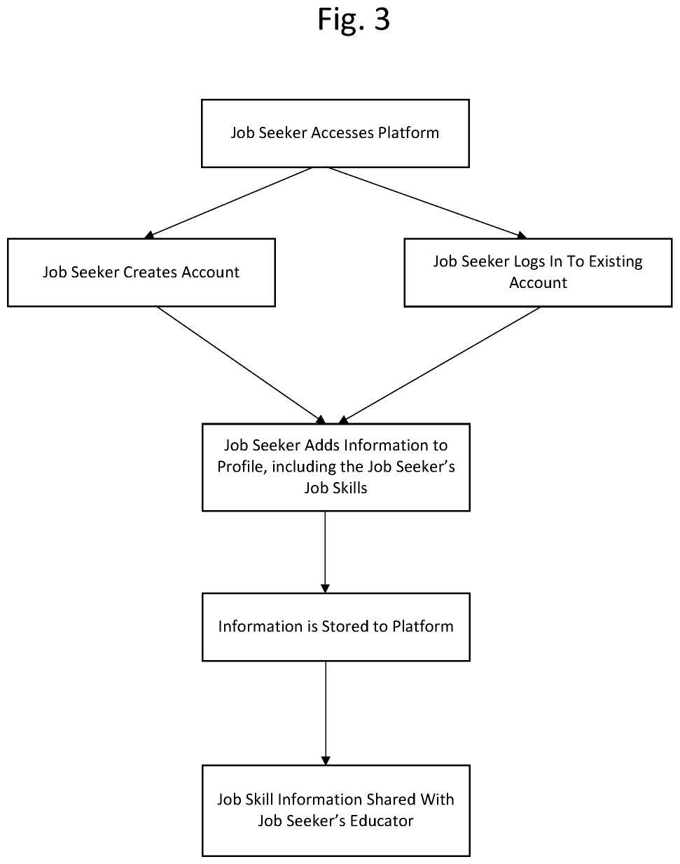

Referring now to FIG. 3 there is conceptually shown a process for a Job Seeker to input the Job Seeker's Job Skills into the Platform. The first step is for a Job Seeker to access the Platform. This may be done using a computer, mobile device, or any other device that provides access to the internet. Subsequently, the Job Seeker may either create an account on the Platform if they do not already have an account or log in to an existing account. Next, the Job Seeker may add information to their User profile, which may include but is not limited to the Job Seeker's name, educational experience, student ID number, as well as any Job Skills possessed by the Job Seeker. To add a Job Skill to the Job Seeker's User profile, the Job Seeker may select one or more Job Skills from a predefined list that is populated by a database of possible Job Skills, or the Job Seeker may input their own custom Job Skill. Job Skills may include any skill that could benefit the performance of a Job, including but not limited to specific computer or software skills, specific personal skills, or specific language skills. Next, information added to the Job Seeker's User profile is stored on the Platform. Finally, the Platform communicates the Job Seeker's Job Skill information to any Educator with a Platform account to whom the Job Seeker is a Student.

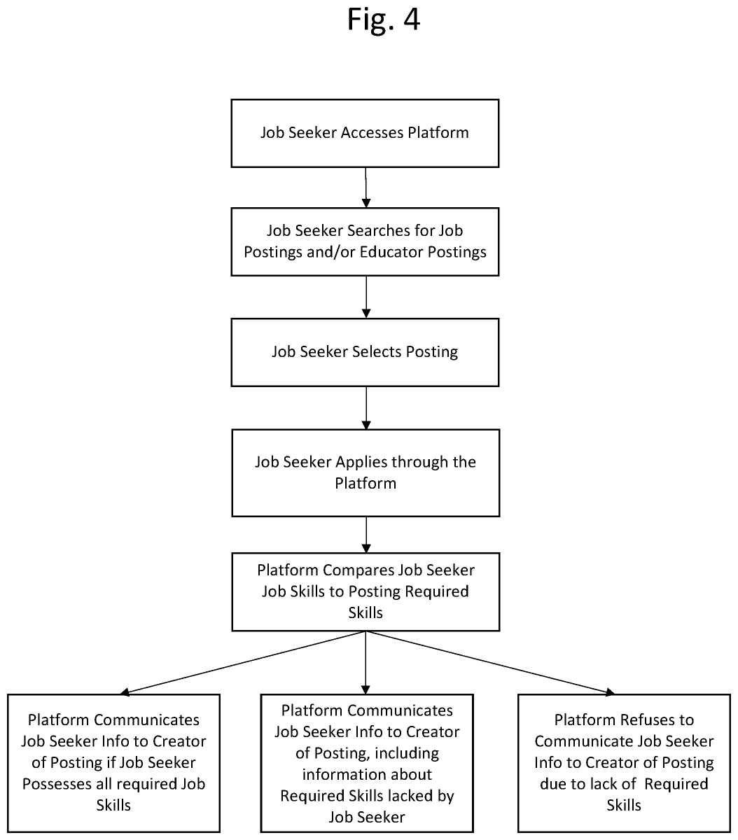

Referring now to FIG. 4 there is conceptually shown a process for a Job Seeker to save and/or apply to a Job Posting or Educator Posting on the Platform. The first step is for a Job Seeker to access the Platform. This may be done using a computer, mobile device, or any other device that provides access to the internet. Subsequently, the Job Seeker may browse or search for Job Postings and/or Educator Posting on the Platform. A Job Seeker may use one or more methods of searching for Job Postings and/or Educator Postings, including but not limited to keyword searches, searches for specific Job Skills or the Job Skill set attributable to the Job Seeker as added to the Job Seeker's User profile, searches for any Job Postings and/or Educator Postings that lists or omits a one or more Job Skills as Required Skills, searches for any Job Postings and/or Educator Postings that lists or omits one or more Job Skills as Acquired Skills, and searching for any Job Postings and/or Educator Postings for which the Job Seeker's User profile includes each and every Job Skill listed as a Required Skill. Next, the Job Seeker selects a Job Posting or Educator Posting from the search results provided by the Platform in the previous step. Next, the Job Seeker may choose to save and/or apply to the Job Posting or Educator Posting using the Platform. Then, the Platform compares the Job Seeker's Job Skills to the Required Skills listed in the Job Posting or Educator Posting. Finally, if the Job Seeker possesses all Required Skills listed in the Job Posting or Educator Posting, the Platform may communicate information from the Job Seeker's User profile to the User who created the Job Posting or Educator Posting to which the Job Seeker applied. Alternatively, if the Job Seeker does not possess all Required Skills listed in the Job Posting or Educator Posting, the Platform may communicate information from the Job Seeker's User profile and information about any Required Skills that the Job Seeker does not possess to the User who created the Job Posting or Educator Posting to which the Job Seeker applied. Alternatively, if the Job Seeker does not possess all Required Skills listed in the Job Posting or Educator Posting, the Platform may refuse to communicate any information about the Job Seeker to the User who created the Job Posting or Educator Posting to which the Job Seeker applied.

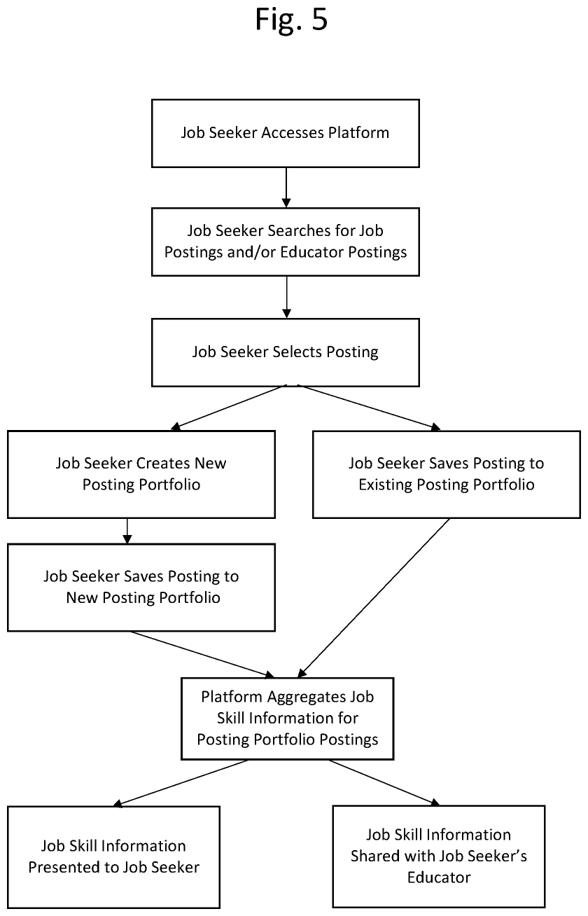

Referring now to FIG. 5 there is conceptually shown a process for a Job Seeker to save a Job Posting or Educator Posting to a Posting Portfolio in the Platform. The first step is for a Job Seeker to access the Platform. This may be done using a computer, mobile device, or any other device that provides access to the internet. Subsequently, the Job Seeker may browse or search for Job Postings and/or Educator Posting on the Platform. A Job Seeker may use one or more methods of searching for Job Postings and/or Educator Postings, including but not limited to keyword searches, searches for specific Job Skills or the Job Skill set attributable to the Job Seeker as added to the Job Seeker's User profile, searches for any Job Postings and/or Educator Postings that lists or omits a one or more Job Skills as Required Skills, searches for any Job Postings and/or Educator Postings that lists or omits one or more Job Skills as Acquired Skills, and searching for any Job Postings and/or Educator Postings for which the Job Seeker's User profile includes each and every Job Skill listed as a Required Skill. Next, the Job Seeker selects a Job Posting or Educator Posting from the search results provided by the Platform in the previous step. Next, the Job Seeker may either save the Job Posting or Educator posting to a previously-created Posting Portfolio, or create a new Posting Portfolio and then save the Job Posting or Educator posting to the new Posting Portfolio. The Platform then aggregates the Job Skill information for each Job Posting or Educator Posting in the Posting Portfolio, which may then be presented to the Job Seeker who created the Posting Portfolio so that the Job Seeker may derive such information as the most commonly occurring Job Skills and which Required Skills the Job Seeker currently lacks. Additionally, the individual or aggregated Job Skill information may be shared with a Job Seeker's Educator User.

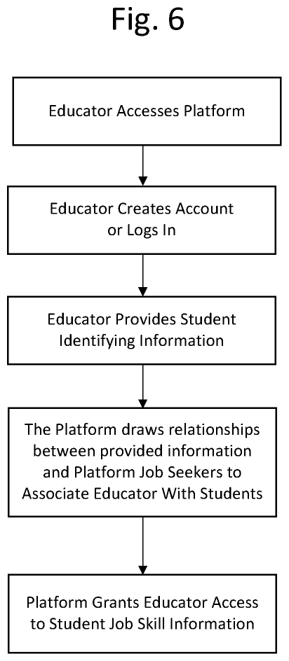

Referring now to FIG. 6 there is conceptually shown a process for an Educator to identify Students and to access Student Job Skill information. The first step is for an Educator to access the Platform. This may be done using a computer, mobile device, or any other device that provides access to the internet. Then, the Educator may either create a User account, or, the Educator may log in to an existing User account. Next, the Educator may input into the platform information to help identify Users who are the Educator's Students. Information that may be provided to help identify an Educator's Students includes but is not limited to student names, student ID numbers, or any other information that may prove a relationship between a Student and the Educator. Then, the Platform identifies Students by identifying relationships between the information provided by the Educator and the information provided by Student Users. Finally, if a relationship is identified, the Platform may grant the Educator Access to information about the Educator's Student's Job Skills and Posting Portfolios.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system for communicating Job Skills information to job market participants comprising:
a Platform listing opportunities for Users to acquire Job Skills;
Platform Users who are Students, Educators, and Employers;
a means for Employer Users to list Job opportunities on the Platform as Job Postings, including information about the Required Skills and Acquired Skills pertaining to each listed Job opportunity;
a means for Educator Users to list Educator Postings on the Platform, including information about the Acquired Skills pertaining to Educator Skills Programs;
a means for Student Users to store information on the Platform, including the Job Skills they possess and their educational information;
a means for Student Users to view the listing of Job Postings and Educator Postings on the Platform;
a means for Student Users to view only the listings of Job Postings and Educator Postings which include information about a specific Job Skill, as determined by the Student User;
a means for Student Users to apply to Job Postings on the Platform;
a means for Student Users to apply to Educator Postings on the Platform;
a means for Student Users to aggregate Job Postings and Educator Postings in one or more Posting Portfolios;
a means for the Platform to reference and compare the Job Skills associated with a Student User against the Required Skills pertaining to a single Job Posting;
a means for the Platform to reference and compare the Job Skills associated with a Student User against the aggregated Required Skills pertaining to the Job Postings saved in a Student User Posting Portfolio;
a means for associating a Student User to one or more Educator Users; and
a means for providing Educator Users with access to information stored on the Platform pertaining to associated Student Users.

2. The system of claim 1 further comprising a means for Student Users to view only the listings of Job Postings and Educator Postings which include information about a specific Job Skill, as determined by the Student User, wherein the specific Job Skill is a Required Skill.

3. The system of claim 1 further comprising a means for Student Users to view only the listings of Job Postings and Educator Postings which include information about a specific Job Skill, as determined by the Student User, wherein the specific Job Skill is an Acquired Skill.

4. The system of claim 1 further comprising a means for the Platform to reference and compare the Job Skills associated with a Student User against the Acquired Skills pertaining to a single Job Posting.

5. The system of claim 1 further comprising a means for the Platform to reference and compare the Job Skills associated with a Student User against the Required Skills pertaining to a single Educator Posting.

6. The system of claim 1 further comprising a means for the Platform to reference and compare the Job Skills associated with a Student User against the Acquired Skills pertaining to a single Educator Posting.

7. The system of claim 1 further comprising a means for the Platform to reference and compare the Job Skills associated with a Student User against the aggregated Required Skills pertaining to the Job Postings saved in a Student User Posting Portfolio.

8. The system of claim 1 further comprising a means for the Platform to reference and compare the Job Skills associated with a Student User against the aggregated Acquired Skills pertaining to the Job Postings saved in a Student User Posting Portfolio.

9. The system of claim 1 further comprising a means for the Platform to reference and compare the Job Skills associated with a Student User against the aggregated Required Skills pertaining to the Educator Postings saved in a Student User Posting Portfolio.

10. The system of claim 1 further comprising a means for the Platform to reference and compare the Job Skills associated with a Student User against the aggregated Acquired Skills pertaining to the Educator Postings saved in a Student User Posting Portfolio.

11. The system of claim 1 wherein Educator Users may access Job Skills information stored on the Platform pertaining to associated Student Users.

12. The system of claim 1 wherein Educator Users may access Posting Portfolios stored on the Platform pertaining to associated Student Users.

13. The system of claim 1 wherein Educator Users may view the aggregated Required Skills pertaining to an associated Student User Posting Portfolio.

14. The system of claim 1 wherein Educator Users may view the aggregated Acquired Skills pertaining to an associated Student User Posting Portfolio.

15. A process for communicating Job Skills information to job market participants comprising:
the creation of Platform User accounts by individuals who are Students, Educators, and Employers;
the listing Job opportunities on the Platform as Job Postings by Employer Users, including information about the Required Skills and Acquired Skills pertaining to each listed Job opportunity;
the listing of Educator Postings on the Platform by Educator Users, including information about the Acquired Skills pertaining to Educator Skills Programs;
the storing of information on the Platform by Student Users, including the Job Skills they possess and their educational information;
the associating of Student Users to one or more Educator Users;
the applying to or saving of opportunity listings by Student Users;
the comparison by the Platform of the Job Skills associated with a Student User against the Job Skills pertaining to listings on the Platform;
the communication of discrepancies between the Job Skills associated with a Student User against the Job Skills pertaining to listings on the Platform to the Student User;
the communication of discrepancies between the Job Skills associated with a Student User against the Job Skills pertaining to listings on the Platform to an Educator User associated with the Student User.

16. The process of claim 15, further comprising the comparison by the Platform of the Job Skills associated with a Student User against the Job Skills pertaining to listings on the Platform, wherein the Job Skills pertaining to listings on the Platform are Required Skills.

17. The process of claim 15, further comprising the comparison by the Platform of the Job Skills associated with a Student User against the Job Skills pertaining to listings on the Platform, wherein the Job Skills pertaining to listings on the Platform are Acquired Skills.
